(19) United States
(12) Patent Application Publication
(10) Pub. No.: US 2003/0213812 A1
(43) Pub. Date: Nov. 20, 2003

(54) Closure assembly and method

(76) Inventors: Herman P. Kars, Amstelveen (NL); Davis B. Dwinell, Carol Stream, IL (US)

Correspondence Address: D. Dwinell, c/o American Flange, 290 E. Fullerton Ave., Carol Stream, IL, 60188, US

(21) Appl. No.: 10/464,683

(22) Filed: Jun. 19, 2003

Related U.S. Application Data
(63) Continuation-in-part of application No. 09/737,622, filed on Dec. 18, 2000, now Pat. No. 6,386,405.

(51) Int. Cl. G01F 11/00

(52) U.S. Cl. 222/1; 222/570

(57) ABSTRACT

A metal or plastic pail lid has a neck construction comprising an opening surrounded by a neck incorporating a locking collar surrounding the neck. A plastic closure assembly has an integrally molded sealing channel having an axially extending inner wall and a peripheral interlocking outer wall. The closure assembly is secured to the neck construction with the spout inner wall guided within the neck opening and the spout outer wall axially forced between the outer surface of the upstanding neck and the inner diameter of the surrounding collar whereupon the sealing channel outer wall is interlockingly squeezed between the neck and the surrounding collar to form a liquid-tight, tamper resistant connection.

This application is a continuation-in-part of U.S. Pat. No. 6,368,405 dated May 14, 2002.

The present invention is directed to an all-plastic dispensing closure assembly for containers and to a method of application of such a dispensing closure assembly to a container. The containers may be open head pails having a metal or plastics lid or a container having a fixed plastic or metal top.

In the field of plastic, injection molded open head pails a transition is taking place toward all-plastic closures. This movement is principally to accommodate environmental recycling concerns and, of course, also to effect attainable cost reductions. The market at this stage has determined that an all-plastic dispensing closure can be snapped on to the upstanding opening neck of a pail lid and successfully meet the various performance criteria set by United Nations and United States Department of Transportation. To date, however, those all-plastic dispensing closures successfully commercialized still leave some gaps in the desirability agenda.

For example, U.S. Pat. No. 5,788,100 dated Aug. 14, 1998 discloses an all-plastic snap-on closure made up of a flexible pouring spout surrounded by an annular sealing channel and fitted with an overlying screw cap. A locking ring is integrally connected about the periphery of the screw cap so as to extend radially outwardly of the spout sealing channel. In application the closure is pressed onto a circumferentially enlarged upstanding opening neck causing the sealing channel to snap there over. During the closure application the locking ring is broken away from the cap periphery and axially pressed around the outer wall of the sealing channel so as to lock the same against the opening neck The result is a very strong closure container wall connection. The downside resides in the fact that the locking ring can be easily pried off without damage, leaving the closure exposed to undetected tampering and pilferage which negatively impacts universal acceptance.

Other examples are U.S. Pat. No. 5,797,525 dated Aug. 25, 1998 and U.S. Pat. No. 5,641,099 dated Jun. 24, 1997 which also show all-plastic snap-on closures made up of a flexible pouring spout surrounded by an annular sealing channel and fitted with an overlying screw cap. These constructions also embody an outer locking ring integrally connected by frangible webs about the periphery of the screw cap. In application, the closure is pressed onto a circumferentially enlarged upstanding opening neck causing both the sealing channel outer wall and the peripheral locking ring to snap thereover. This arrangement causes both the spout outer sealing channel and the peripheral locking ring to expand over the neck enlargement and then relies solely on the elastic memory of the plastic parts to radially contract below the neck enlargement and hold the parts tightly together. The principal problem with this type of construction is the inability under varied manufacturing conditions to consistently retain a tight seal due to elastic memory alone. In addition undetected tampering can also be readily accomplished by simply prying the fitting off of the opening neck.

### SUMMARY OF INVENTION

It is an object of the present invention to provide a container neck construction and method of application of a closure assembly combination to such a container neck construction that overcomes these prior art deficiencies in a very simple and straight forward manner. As explained above, the current prior art practice is to one way or another, during application, surround the fully seated sealing channel outer wall with a locking ring introduced as an integral part of the closure.

According to the present invention, a container neck construction and closure assembly combination includes an upstanding neck. The closure assembly is all-plastic and has an annular sealing channel to surround and sealingly engage the neck. Locking means surround the sealing channel to lock the sealing channel against the neck. By this means, the locking ring differs from prior art combinations in that, instead of being a separable part of the closure assembly, it is integrally molded or otherwise formed in the neck construction part of the pail lid as a raised annular collar spaced from and surrounding the upstanding opening neck. The outer wall of the spout sealing channel is, during application, then squeezed into the annular gap formed between the neck and the collar creating a very strong, liquid tight engagement between the closure and the pail lid. The advantages of the present invention closure and method are immediately apparent. There is no breaking away of relatively fragile parts which are then stretched around other parts. There is no reliance on elastic memory for holding parts together. Most importantly, the tamper resistance of the invention closure is substantially increased, as there is no readily undetectable way the fitting or any part thereof can be pried off the pail lid. This characteristic in itself clearly distinguishes the present invention over other snap-on all-plastic closures currently in use. Moreover, the ultimate simplicity of application of the closure assembly to the neck construction of the pail lid easily constitutes a further advance in the art.

The neck construction may be part of a plastics or metal lid for an open head pail. If the pail lid is plastic, the locking means is a locking collar concentrically disposed radially outwardly spaced from the neck. If the pail lid is metal, an open annular groove may be concentrically disposed radially outwardly spaced from the neck, the radially outer groove wall forming the locking collar or the locking collar may be formed by an upstanding fold in the lid and radially outwardly spaced from the neck.

The above and other features of the present invention, are illustrated, by way of example, in the drawing wherein:

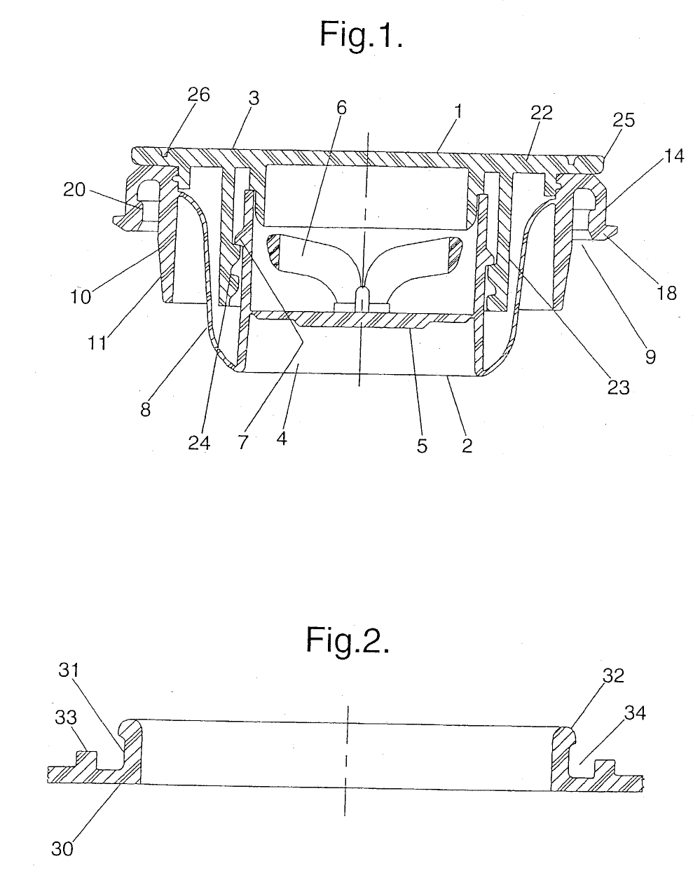

FIG. 1 is a vertical sectional view of a closure assembly in accordance with a first embodiment of the present invention, prior to application to a container neck construction;

FIG. 2 is a vertical sectional view of a container neck construction in accordance with the first embodiment of the present invention;

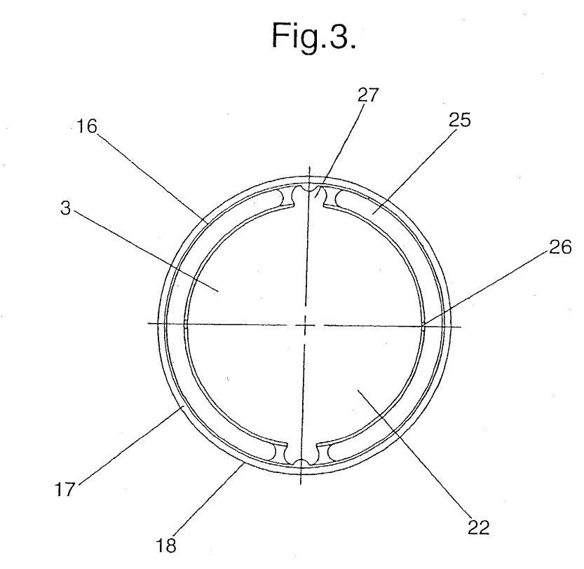

FIG. 3 is a top plan view of a closure assembly in accordance with the first embodiment of the present invention;

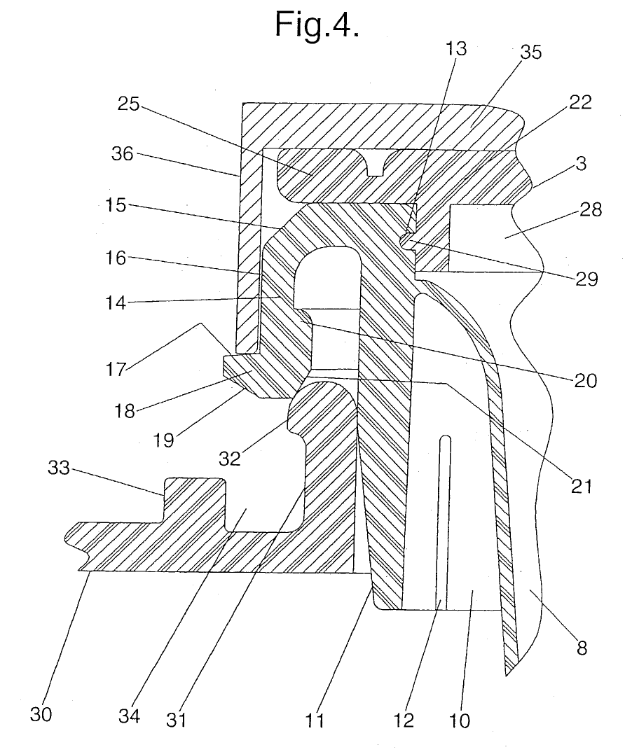

FIG. 4 is a partial vertical sectional view showing the closure assembly of FIG. 3 initially positioned on the neck construction of FIG. 2;

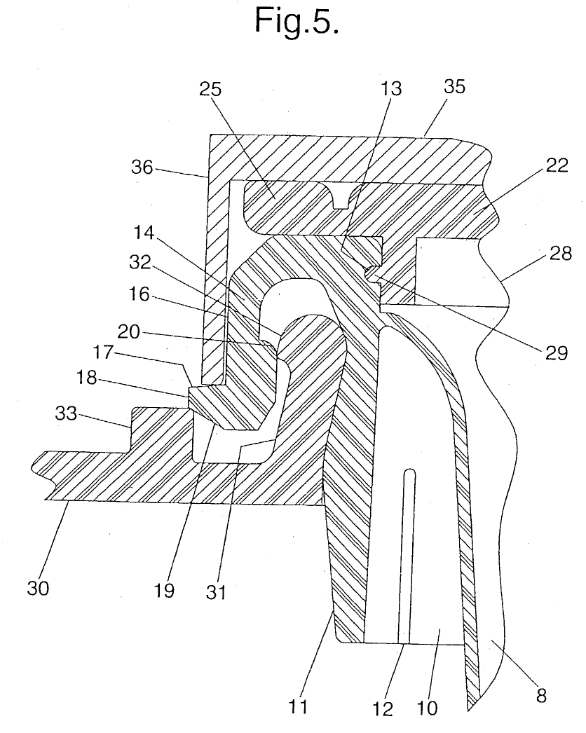

FIG. 5 is a view similar to FIG. 4 and showing the closure assembly in an intermediate position during application;

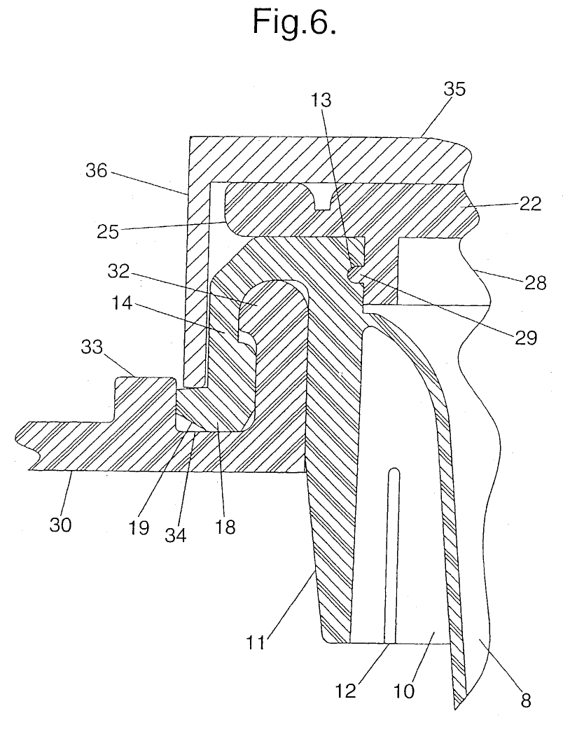

FIG. 6 is another view similar to FIG. 4 showing the closure assembly in fully seated and interlocked final position;

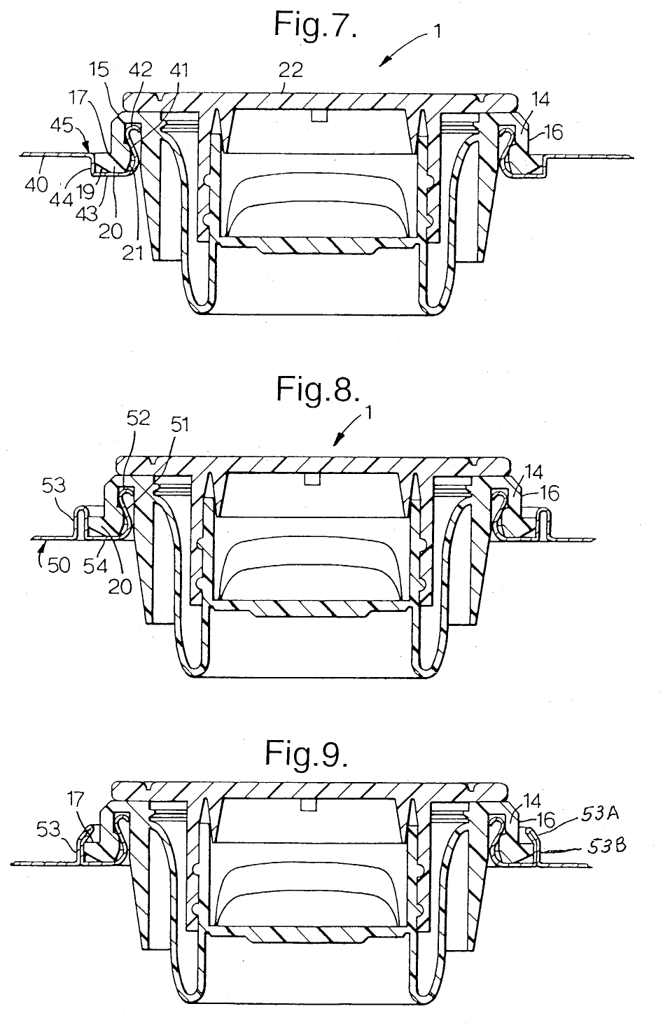

FIG. 7 is a vertical sectional view of a closure assembly in fully seated and interlocked final position with a neck construction in accordance with a second embodiment of the present invention;

FIG. 8 is a vertical sectional view of a closure assembly in a partially seated position with a neck construction in accordance with a third embodiment of the present invention; and,

FIG. 9 is a view of the closure assembly of FIG. 8 in fully seated and interlocked final position in accordance with the method of the invention.

### DETAILED DESCRIPTION OF THE INVENTION

As shown by FIGS. 1 to 6, a first embodiment of an all-plastic container closure assembly, generally indicated at numeral 1 in FIG. 1, is seen to consist of a nestable pouring spout 2 molded of low density polyethylene and an overlying screw cap 3 molded of high density polyethylene or similar plastic. The spout is formed with an axially extending dispensing neck 4 closed off by a tear-out membrane 5 having a ring pull 6. The upper portion of the neck 4 has an external thread 7 and the lower end of the neck is integrally connected to flexible wall 8 in turn joined at its uppermost end to a circumferential sealing channel 9. The sealing channel 9, as clearly seen in FIG. 4, has an axially elongated inner cylindrical wall 10 which extends beyond the vertical midpoint of flexible wall 8 and has a downwardly and inwardly extending conical surface 11 further provided with one or more vertical drainage slots 12. At the upper end portion of inner channel wall 10 above the juncture of spout flexible wall 8 there is an annular, undercut, retaining groove 13. The sealing channel 9 is further provided with an outer wall 14 having an exterior upward and radially outwardly facing camming surface 15 at its upper end. Camming surface 15 joins a cylindrical outer surface 16 which terminates in an annular upwardly facing load bearing surface or shelf 17 on circumferential presser foot 18. The bottom of presser foot 18 has a downwardly and radially outwardly facing camming surface 19. The inner surface of outer sealing channel wall 14 has an internal bead 20 partially closing off the mouth of the sealing channel and terminating at its lowermost end in radially inwardly and downwardly facing camming surface 21.

The screw cap 3 has a disc like top 22 with a central cylindrical sidewall 23 depending therefrom and having an internal thread 24 for engagement with the spout thread 7. A pair of lifting bails 25 surround the cap top 22 and are connected by a series of frangible webs 26 and diametrically opposed hinge points 27. The screw cap 3 is further provided with a short skirt 28 depending from the periphery of top 22. An annular locking rib 29 surrounds the lower skirt portion and engages within the spout groove 13 with the cap in assembled position.

As seen in FIG. 2, a plastics pail lid has a neck construction 30 comprising an upstanding neck 31 surrounding the standard dispensing opening and terminating in a circumferentially enlarged retaining lip 32 and a locking collar 33 concentrically disposed radially outwardly spaced from neck 31 creates an open annular groove 34.

Turning to the insertion process as initially viewed in FIG. 4, the closure 1 is placed on the neck 31 with the inner sealing channel wall 10 entering the lid opening and the conical wall surface 11 acting as a guide. In this position the sealing channel outer wall camming surface 21 rests on the neck lip 32. An axially driven insertion tool 35 having an outer cylindrical wall 36 is placed over the closure with the camming surface 15 acting as a guide so that the lower end of the wall 36 comes in contact with the presser foot bearing surface 17 as the tool body bears against the top of cap 22. Continued vertical displacement of the tool 35 against the supported pail lid 30 causes the camming surface 21 on bead 20 to squeeze the neck 31 and inner sealing channel wall 18 radially inwardly a small amount a shown in FIG. 5 and due to the pressure of the insertion tool outer wall 36 against the cylindrical surface 16. At this point the presser foot camming surface 19 is brought into engagement with the inner top corner of the locking collar 33. As shown in FIG. 6 the final small amount of vertical displacement bumps the presser foot inside the collar 33 so that the bottom surface of the outer channel wall 14 rests against the bottom of groove 34. In this position it can be seen that the internal bead 20 has moved past the neck lip 32 and become locked securely there under. The insertion tool 35 is then retracted leaving the closure tightly and permanently applied to the container neck construction.

A second embodiment of a combined closure assembly and neck construction in accordance with the present invention is shown in FIG. 7, wherein like parts have been given the same reference numerals. The closure assembly 1 is essentially the same as the closure assembly of FIGS. 1 to 6, absent the locking rib 29.

A metal pail lid has a pail lid 40 having an upstanding neck 41 surrounding the standard dispensing opening and terminating in a circumferentially enlarged retaining lip 42. An open annular groove 43 is concentrically disposed radially outwardly spaced from neck 41, the radially outer groove wall 44 of the groove forming a locking collar 45.

The closure assembly 1 makes a simple snap-fit with the neck construction 41 with the sealing channel outer wall camming surface 21 resting on the neck lip 42. An axially driven insertion tool (not shown, but similar to insertion tool 35 of FIGS. 4 to 6) is placed over the closure assembly with the camming surface 15 acting as a guide so that the lower end of the insertion tool outer wall comes in contact with the presser foot bearing surface 17 as the tool body bears against the cap top 22. Continued vertical displacement of the tool against the supported pail lid 40 causes the inner camming surface 21 on bead 20 to squeeze the opening neck and inner sealing channel wall radially inwardly a small amount, due to the pressure of the insertion tool outer wall against the sealing channel cylindrical surface 16. At this point the presser foot camming surface 19 is brought into engagement with the inner top corner of the locking collar 45. A final small amount of vertical displacement bumps the presser foot inside the collar 45 so that the bottom surface of the outer channel wall 14 rests against the bottom of groove 43. In this position it can be seen that the internal bead 20 has moved past the neck lip 42 and become locked securely thereunder. The insertion tool is then retracted, leaving the closure tightly and permanently applied to the container opening.

A third embodiment of a combined closure assembly and neck construction in accordance with the present invention is shown in FIGS. 8 and 9, again like parts have been given the same reference numerals. The closure assembly 1 is essentially the same as the closure assembly of FIGS. 1 to 6, absent the locking rib 29.

A metal pail lid 50 has an upstanding neck 51 surrounding the standard dispensing opening and terminating in a circumferentially enlarged retaining lip 52 and an upstanding fold in the lid forms a locking collar 53 having an upper portion 53A and a lower portion 53B. Collar 53 is concentrically disposed radially outwardly spaced from neck 51, creating an open annular groove 54. Assembly is the same as described for the second embodiment except that, once the internal bead 20 has moved passed the neck lip 52 and become locked securely there-under, it is further secured by crimping the locking collar upper portion 53A radially inwardly over the presser foot 17; as shown in FIG. 9.

From the foregoing the numerous advantages of the present invention are readily apparent, first and foremost, the closure is substantially more tamper resistant than other all-plastic closure constructions. Vertical retraction of the presser foot 18 from-the groove 34 is prevented by the interlocking undercuts between the opening neck and the outer channel wall. Prying the presser foot out of the groove 34 is a virtual impossibility without clear indication of tampering. The high radial compression created between the collar 30 and the inner channel wall 10 assures a liquid seal under the most rigorous conditions. In addition the radial contraction of the spout inner wall serves to effectively tighten the engagement with the cap skirt 28 so that inadvertent dislodgment of the locking of the locking rib 29 with the groove 13 becomes unlikely due to unavoidable upward force or pressure on the bottom of the nested spout. A further advantage in the construction according to the present invention is the ability to also apply, if need be, a conventional crimped-on closure to the opening neck configuration. This flexibility has significant commercial ramifications.

Various other changes in or modifications to the closure assembly and neck construction combination and insertion method of the invention; for example, different types of plastic resin could be employed to mould the various elements; the neck construction could form part of the top of a metal or plastic container, such as an oil can.

We claim:

1. In combination, a metal pail lid having a closure receiving opening therein, said opening surrounded by an upstanding neck terminating in a circumferentially enlarged retaining lip, an annular upstanding locking collar surrounding said neck radially spaced therefrom, a synthetic plastic resin dispensing closure seated on said upstanding neck having an integrally connected outer wall surrounding said neck in sealing engagement therewith, said outer wall radially compressed within said locking collar and said collar deformed radially inwardly so as to restrain said dispensing closure outer wall against axial displacement.

2. The combination of claim 1 and said outer wall forming part of a peripheral sealing channel.

3. The combination of claim 2 and said sealing channel having an inner wall extending axially within said neck.

4. The combination of claim 1 and said dispensing closure including a nestable pouring spout.

5. In combination, a metal pail lid having a closure receiving opening therein, said opening surrounded by closure engaging means, an annular upstanding double walled locking collar surrounding said neck radially spaced therefrom, said locking collar having an upper portion and a lower portion,a synthetic plastic resin dispensing closure tightly engaged within said opening, an integrally molded outer wall surrounding said dispensing closure, said outer wall radially compressed within said locking collar and said collar upper portion deformed radially inwardly so as to partially overlie said dispensing closure outer wall.

6. The combination of claim 5 and said double walled locking collar comprising an upstanding fold.

7. The combination of claim 5 and said dispensing closure including a nestable pouring spout.

8. The method of affixing a synthetic plastic resin dispensing closure to a metal container lid opening surrounded by closure engaging means and having an upstanding collar surrounding said closure engaging means radially spaced therefrom, said closure having an integrally molded outer wall comprising the steps of:
a) introducing said closure within said opening,
b) seating said closure outer wall tightly within said upstanding collar,
b) deforming said upstanding collar radially inwardly, and
d) exerting a compressive force between said collar and said outer wall.
